(19) United States
(12) Patent Application Publication
(10) Pub. No.: US 2026/0180886 A1
(43) Pub. Date: Jun. 25, 2026

(54) METHOD FOR THE PROCESSING OF A DATA PACKET BY A DATA FLOW CONTROL UNIT IN A COMMUNICATION NETWORK

(71) Applicant: Robert Bosch GmbH, Stuttgart (DE)

(72) Inventors: Abdulkadir Karaagac, Renningen (DE); Jan Hoffmann, Pforzheim (DE); Marie-Theres Suer, Braunschweig (DE)

(21) Appl. No.: 19/422,697

(22) Filed: Dec. 17, 2025

(30) Foreign Application Priority Data
Dec. 20, 2024 (DE) 10 2024 212 229.7

(51) Int. Cl. H04L 43/106; H04L 43/0852; H04L 47/24

(52) U.S. Cl. CPC H04L 43/106; H04L 43/0852; H04L 47/24

(57) ABSTRACT

A method for the processing of a data packet by a data flow control unit in a communication network. The method includes: reception of the data packet, wherein at least one timestamp is provided for the data packet; ascertainment of a processing time for the data packet by the data flow control unit based on the at least one timestamp; determination of a difference between the at least one timestamp and a current time; processing of the data packet by the data flow control unit depending on the determined difference and the ascertained processing time. A computer program, a device, and a storage medium are also described.

### FIELD

The present disclosure relates to a method for the processing of a data packet by a data flow control unit in a communication network. The present disclosure furthermore relates to a computer program, a device, and a storage medium for this purpose.

### BACKGROUND INFORMATION

Data flow control units such as firewalls are widely recognized as essential components for protecting systems from unauthorized access and cyber threats. They play a crucial role in filtering network traffic, preventing data leaks, and ensuring the integrity of critical operations. However, with technological advancements and the growing need for efficiency, the demand for more modular and more flexible firewall implementations is increasing. This shift brings new challenges and requirements for network and security measures, in particular in real-time environments.

In certain applications, time-critical data refer to information that quickly becomes outdated if it is not transmitted within a specific timeframe. These data are characterized by their time-critical nature, with their relevance and accuracy decreasing rapidly over time. Industries such as finance, logistics, and emergency services rely heavily on real-time information for decision-making. For example, real-time sensor readings from IoT devices, such as temperature, humidity, and air quality, are crucial in manufacturing and environmental monitoring.

Traditional network provisioning can lead to inefficiencies in the processing of time-critical data packets that have experienced excessively long delays so that they cannot or should not be used anymore. Despite their outdated nature, these data packets are typically still processed and forwarded by network components and firewalls, leading to inefficient utilization of network resources. Only the destination instance of the data packets discards the information.

Examples of shortcomings in the related art include the following. Traditional firewalls process and forward time-critical data packets even if they are outdated due to excessive network delays. This leads to inefficient utilization of network resources. Outdated data packets consume valuable computing power and network bandwidth, which can lead to delays in the delivery of relevant and current time-critical data. The processing and forwarding of outdated data packets contributes to unnecessary network congestion, which can affect the overall performance and responsiveness of the network. Real-time environments require immediate access to accurate and timely information. The presence of outdated data packets impairs the efficiency of critical processes in industries such as emergency services or manufacturing.

### SUMMARY

Present disclosure includes a method, a computer program, a device, and a computer-readable storage medium. Features and details of embodiments of the present disclosure can be found herein. Features and details that are described in connection with the method according to the present disclosure of course also apply in connection with the computer program according to the present disclosure, the device according to the present disclosure, and the computer-readable storage medium according to the present disclosure, and vice versa in each case, so that mutual reference can also always be made with regard to the disclosure.

The subject matter of the present disclosure includes in particular a method for the processing of a data packet by a data flow control unit, in particular a firewall, in a communication network. According to an example embodiment, the method includes:
reception of the data packet, wherein at least one timestamp is provided for the data packet, wherein the at least one timestamp can specify a specific processing time of the data packet, such as a time of transmission or reception by a specific data processing device and/or by the data flow control unit,
ascertainment of a processing time for the data packet by the data flow control unit, or firewall, on the basis of the at least one timestamp, wherein the processing time, in simplified terms, expresses in particular how much time the data flow control unit has to process the data packet and subsequently send it on (to a further data processing device),
determination of a difference between the at least one timestamp and a current time,
processing of the data packet by the data flow control unit depending on the determined difference and the ascertained processing time, wherein the processing may be, for example, filtering, wherein certain rules of the data flow control unit can be applied in order to filter out specific data packets.

The communication network may be a distributed system in which, for example, an industrial network with various sensors and/or actuators communicates with a (cloud) server via the data flow control unit according to the present disclosure. For example, the (cloud) server may retrieve sensor data from the sensors and/or control the actuators.

In other words, the present disclosure provides, in particular, a method for the processing of data packets in a data flow control unit, which method is based on timestamps. The method according to the present disclosure can advantageously allow outdated data packets to be filtered out, whereby efficiency can be increased and data load in the communication network can be improved.

Advantageously, the present disclosure may provide that the at least one timestamp is provided by the data flow control unit at the time of reception, wherein the data flow control unit furthermore defines a time budget for the processing time. This allows the data flow control unit to control the processing time of the data packet precisely and to ensure that time-critical data are processed quickly. Setting the time budget can make it possible for the data flow control unit to utilize computing resources more efficiently and to avoid delays in the processing of non-time-critical data packets.

It may be advantageous if, within the scope of the present disclosure, the at least one timestamp was provided by a source data processing device, for example a first device of the communication network that has sent the data packet to the data flow control unit. The at least one timestamp may specify an expected arrival time of the data packet at a destination data processing device, for example a second device of the communication network. Alternatively or additionally, the at least one timestamp can specify a time of transmission of the data packet by the source data processing device and a time budget for the processing time by the data flow control unit. In this way, the data flow control unit can be provided with additional information about the data packet through the timestamp provided by the source data processing device. This additional information allows the data flow control unit to decide even more accurately how to handle the data packet and whether it might be outdated. This can improve the efficiency of the data flow control unit and optimize the network performance of the communication network.

Furthermore, it may be provided within the scope of the present disclosure that the processing comprises:
discarding of the data packet if the difference exceeds or falls below a defined threshold value.

It is therefore possible that outdated data packets are discarded by the data flow control unit on the basis of the difference between the timestamp and the current time. This can increase efficiency by preventing the processing of unnecessary data packets.

Furthermore, within the scope of the present disclosure, it may be advantageous for the processing to comprise:
assignment of a low priority to the data packet if the difference exceeds or falls below a defined threshold value.

It is therefore possible that data packets with outdated timestamps obtain a lower priority in the processing and are processed later, i.e., only after data packets with a higher priority. This allows, for example, time-critical data packets to be given priority.

According to a further advantage, it may be provided that at least two data packets or even a plurality of data packets are received as part of the reception, and that the processing comprises:
ascertainment of a sequence for the processing of the at least two data packets or the plurality of data packets depending on the determined difference.

This allows time-critical data packets to be processed preferentially, or first.

It is also optionally possible that the ascertainment of the processing time is furthermore performed on the basis of a priority property and/or a real-time property of the data packet. The priority property of the data packet specifies in particular a priority level of the data packet, and the real-time property of the data packet specifies in particular whether the data packet is a data packet for a real-time application. By taking into account the priority property and/or the real-time property of the data packet, time-critical and/or higher-priority data packets can be processed preferentially, while less urgent packets can be delayed or postponed. This leads in particular to optimized resource allocation within the data flow control unit and can make more reliable data delivery possible for applications with different requirements, e.g., for latency.

It is possible for the method according to the present disclosure to be used in a vehicle. The vehicle can be designed, for example, as a motor vehicle and/or passenger vehicle and/or as an at least partially automated/autonomous vehicle. The vehicle may comprise a vehicle device, for example for providing an autonomous driving function, and/or a driver assistance system. The vehicle device may be designed to at least partially automatically control and/or accelerate and/or brake and/or steer the vehicle.

The present disclosure also relates to a computer program, in particular a computer program product, comprising commands which, when the computer program is executed by at least one computer, cause the computer to carry out the method according to the present disclosure. The computer program according to the present disclosure thus delivers the same advantages as have been described in detail with reference to a method according to the present disclosure.

The present disclosure also relates to a data processing device configured to carry out the method according to the present disclosure. For example, at least one computer which executes the computer program according to the present disclosure can be provided as the device. The computer may have at least one processor for executing the computer program. A non-volatile data memory may also be provided, in which the computer program is stored and from which the computer program can be read by the processor for execution.

The present disclosure may also relate to a computer-readable storage medium which comprises the computer program according to the present disclosure and/or commands which, when executed by at least one computer, cause the computer to carry out the method according to the present disclosure. The storage medium is formed, for example, as a data memory such as a hard drive and/or a non-volatile memory and/or a memory card. The storage medium may be integrated into the computer, for example.

Furthermore, the method according to the present disclosure may also be designed as a computer-implemented method. Alternatively or additionally, at least one of the disclosed method steps may be computer-implemented and/or performed automatically.

Further advantages, features, and details of the present disclosure can be found in the following description, in which exemplary embodiments of the present disclosure are described in detail with reference to the figures. The features mentioned in herein may be essential to the present disclosure in each case, either individually or in any combination.

### BRIEF DESCRIPTION OF THE DRAWINGS

FIG. 1 is a schematic visualization of a method, a device, a storage medium and a computer program according to exemplary embodiments of the present disclosure.

FIG. 2 is a schematic representation of a communication network according to exemplary embodiments of the present disclosure.

### DETAILED DESCRIPTION OF EXAMPLE EMBODIMENTS

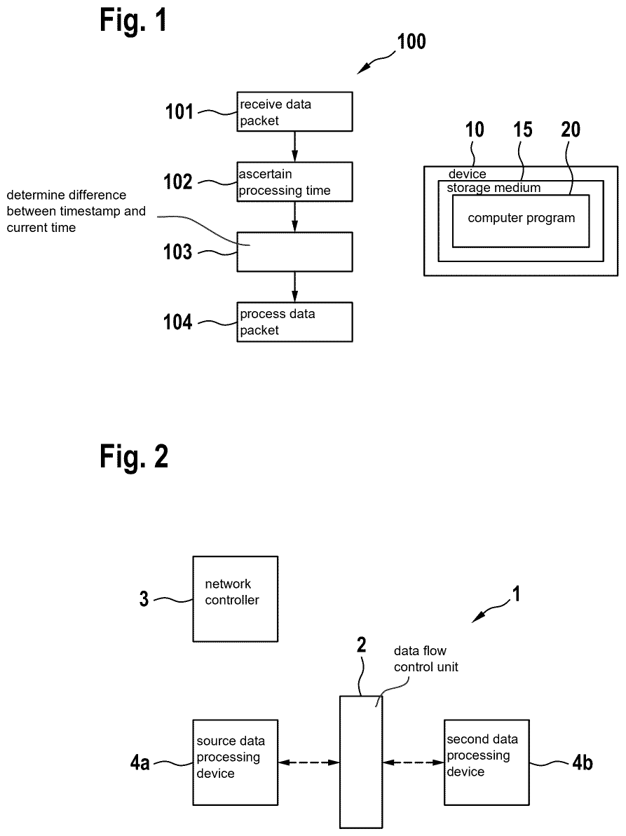

FIG. 1 schematically shows a method 100, a device 10, a storage medium 15, and a computer program 20 according to exemplary embodiments of the present disclosure.

FIG. 1 shows in particular an exemplary embodiment of a method 100 for the processing of a data packet by a data flow control unit 2 in a communication network 1. In a first step 101, the data packet is received, wherein at least one timestamp is provided for the data packet. In a second step 102, a processing time for the data packet is ascertained by the data flow control unit 2 on the basis of the at least one timestamp. In a third step 103, a difference between the at least one timestamp and a current time is determined. In a fourth step 104, the data packet is processed by the data flow control unit 2 depending on the determined difference and the ascertained processing time.

FIG. 2 is a schematic representation of a communication network 1 with a data flow control unit 2, in particular a firewall, according to exemplary embodiments of the present disclosure. Here, by way of example, a source data processing device 4a, such as an industrial network with various sensors and actuators, communicates with a second (external) destination data processing device 4b, such as a (cloud) server. Furthermore, the communication network 1 comprises a network controller 3.

One goal of the present disclosure is in particular to provide a novel data flow control unit 2, in particular a firewall, which eliminates inefficiencies caused by the processing and forwarding of outdated data packets in conventional network provisioning. One goal, for example, is to optimize network performance by prioritizing the timely delivery of time-critical data packets and avoiding unnecessary utilization of computing resources.

By addressing the challenges and shortcomings of the current related art, the present disclosure, according to exemplary embodiments, aims in particular at improving network efficiency, reducing congestion, and improving the provision of timely and relevant time-critical data in real-time environments.

The present disclosure deals in particular with inefficiencies caused by the processing and forwarding of outdated data packets, in that novel techniques for the intelligent identification and elimination of outdated data packets are integrated within the data flow control unit 2, or firewall, thereby prioritizing the timely provision of relevant and current time-sensitive data packets.

The present disclosure can significantly improve network performance and network efficiency by eliminating the processing and forwarding of outdated data packets. This can lead to smoother network processes, lower latency, and an overall better responsiveness of the communication network 1.

By prioritizing the timely delivery of relevant and current time-critical data packets, the solution according to the present disclosure can make a higher quality of service possible. The solution according to the present disclosure can furthermore provide more deterministic behavior and consistent and reliable connectivity. This is advantageous in particular in real-time environments where uninterrupted and predictable network connectivity is crucial. The solution according to the present disclosure can optimize the utilization of computing resources by eliminating the processing and forwarding of outdated data packets. This frees up valuable processing power and network bandwidth, making it possible to more efficiently utilize the computing resources. The data flow control unit 2 can also provide improved visibility of the network traffic and thus better identification and analysis of the causes of timing problems. This makes proactive troubleshooting and optimization of network performance possible, for example. The present disclosure can furthermore prevent network congestion effectively by promptly discarding outdated data packets. This makes it possible to optimize the utilization of network resources, reduce bottlenecks, and ensure more efficient data flow.

The solution according to the embodiments of the present disclosure comprises in particular two approaches for the intelligent identification and elimination of outdated data packets, whereby the timely delivery of relevant and current time-critical data can be ensured.

A first approach according to the present disclosure may be the provision of time specifications by the data flow control unit 2 itself. A crucial aspect of this approach is, in particular, the implementation of a predefined or communicated time budget for critical data traffic while this data traffic is being processed by the data flow control unit 2, i.e., while it moves from the input to the output. In order to achieve this, all critical data packets can be provided with a timestamp upon entry into the data flow control unit 2. This timestamp allows the data flow control unit 2 to check, in particular, whether the data packets have exceeded the predefined waiting time in the queue, before they are processed and rules are applied. If the specified time has expired, the data flow control unit 2 can promptly discard the data packet without further processing, thus ensuring efficient handling of time-critical data. By setting a time budget, the data flow control unit 2 can optimize the processing of critical data traffic, reduce delays, and improve the overall performance of the communication network 1.

A first approach according to the present disclosure may be a time specification for an end-to-end delivery. In addition to the first approach, this solution can include a further method in order to ensure the delivery of timely and relevant data packets. Each data packet can comprise a timestamp specifying either a time of transmission by a source data processing device 4a and/or an expected arrival time at a destination data processing device 4b. The data flow control unit 2 can check whether the data packets have exceeded the predefined network delay budget or the queue waiting time, before they are processed and rules are applied. If the deadline has expired, the data flow control unit 2 can immediately discard the data packet without further processing. This approach can ensure that only data packets with valid timestamps indicating that they are within the permissible delay limits are processed and forwarded.

By combining these two approaches, the data flow control unit 2 according to the present disclosure can intelligently identify and eliminate outdated data packets, thereby significantly improving network performance, optimizing resource utilization, and increasing overall efficiency.

Alternatively or additionally, the data flow control unit 2 according to the present disclosure can use a priority of the data packets in both approaches in order to ascertain a processing sequence.

As an alternative to discarding the outdated data packets directly, the data flow control unit 2 may set a minimum priority for these outdated data packets, while the data packets with the minimum remaining time budget could still be the first to be processed.

In order to implement the first approach, it may be important to transmit time budgets to the data flow control unit 2. This can be achieved through direct communication between the end devices (source 4a/destination 4b) and the data flow control unit 2. Alternatively, the network controller 3 (such as CNC/CUC in TSN) can play a role in forwarding the required time budget to the data flow control unit 2 and can ensure that the time budget matches the specific data traffic requirements.

In order to implement the second approach effectively, it may be crucial to ensure time synchronization between the data flow control unit 2 and devices 4a, 4b of the communication network 1, in particular for devices that transmit real-time data traffic with time specifications. This synchronization can make it possible for the data flow control unit 2 to identify the time specifications accurately by examining the timestamps available in the processed data packets.

The data flow control unit 2 according to the present disclosure can offer significant advantages in various areas, in particular in complex network architectures with demanding applications. One such area is, for example, the industrial sector, where applications such as automation, industrial control and industrial IoT can greatly benefit from improved deterministic connectivity.

The above description of the embodiments describes the present disclosure exclusively in the context of examples. Of course, individual features of the embodiments, provided they are technically feasible, can be freely combined with one another without departing from the scope of the present disclosure.

1-10. (canceled)

11. A method for processing a data packet by a data flow control unit in a communication network, the method comprising the following steps:
receiving the data packet, wherein at least one timestamp is provided for the data packet;
ascertaining a processing time for the data packet by the data flow control unit based on the at least one timestamp;
determining a difference between the at least one timestamp and a current time; and
processing the data packet by the data flow control unit depending on the determined difference and the ascertained processing time.

12. The method according to claim 11, wherein the at least one timestamp is provided by the data flow control unit at a time of the receiving of the data packet, wherein the data flow control unit furthermore defines a time budget for the processing time.

13. The method according to claim 11, wherein:
the at least one timestamp was provided by a source data processing device that sent the data packet to the data flow control unit, and
the at least one timestamp: (i) represents an expected arrival time of the data packet at a destination data processing device, and/or (ii) specifies a time of transmission of the data packet by the source data processing device and a time budget for the processing time by the data flow control unit.

14. The method according to claim 11, wherein the processing includes:
discarding the data packet when the difference exceeds or falls below a defined threshold value.

15. The method according to claim 11, wherein the processing includes:
assigning a low priority to the data packet when the difference exceeds or falls below a defined threshold value.

16. The method according to claim 11, wherein at least two data packets are received as part of the receiving step, and the processing includes:
ascertaining a sequence for the processing of the at least two data packets depending on the determined difference.

17. The method according to claim 11, wherein the ascertaining of the processing time is furthermore performed based on a priority property of the data packet and/or a real-time property of the data packet.

18. A data processing device configured to carry out a method for processing a data packet by a data flow control unit in a communication network, the method comprising the following steps:
receiving the data packet, wherein at least one timestamp is provided for the data packet;
ascertaining a processing time for the data packet by the data flow control unit based on at least one timestamp;
determining a difference between the at least one timestamp and a current time; and
processing the data packet by the data flow control unit depending on the determined difference and the ascertained processing time.

19. A non-transitory computer-readable storage medium on which are stored commands for processing a data packet by a data flow control unit in a communication network, the commands, when executed by at least one computer, causing the at least one computer to perform the following steps comprising:
receiving the data packet, wherein at least one timestamp is provided for the data packet;
ascertaining a processing time for the data packet by the data flow control unit based on at least one timestamp;
determining a difference between the at least one timestamp and a current time; and
processing the data packet by the data flow control unit depending on the determined difference and the ascertained processing time.
